(19) United States
(12) Patent Application Publication
(10) Pub. No.: US 2015/0223000 A1
(43) Pub. Date: Aug. 6, 2015

(54) Personal Noise Meter in a Wearable Audio Device

(71) Applicant: Plantronics, Inc., Santa Cruz, CA (US)

(72) Inventors: Cary Bran, Seattle, WA (US); Shantanu Sarkar, San Jose, CA (US); Timothy P. Johnston, Los Gatos, CA (US)

(73) Assignee: Plantronics, Inc., Santa Cruz, CA (US)

(21) Appl. No.: 14/172,215

(22) Filed: Feb. 4, 2014

(51) Int. Cl. H04R 29/00

(52) U.S. Cl. CPC H04R 29/00

(57) ABSTRACT

A wearable audio device having corresponding computer-readable media comprises: a processor; a microphone configured to provide first audio to the processor, wherein the first audio represents first sounds received by the microphone; and a loudspeaker configured to receive second audio from the processor, and to produce second sounds based on the second audio; wherein the processor is configured to generate a noise dose parameter based on the first audio.

### FIELD

The present disclosure relates generally to the field of audio processing. More particularly, the present disclosure relates to noise measurement in a wearable device.

### BACKGROUND

In a work environment, the accumulated amount of noise, or noise dose in terms of an average noise level, and the maximum level of noise to which an individual has been exposed during a workday, are important to occupational safety and to the health of the individual. Industry and governmental agencies in countries throughout the world, such as the Occupational Safety and Health Administration (OSHA) in the United States, require highly accurate noise data measurements.

Noise dosimeters have been developed to obtain such noise data measurements. However, these dosimeters are expensive dedicated units that are purchased only for the purpose of obtaining highly accurate noise data measurements. Furthermore, these dosimeters must be calibrated on a regular basis, incurring further expense.

### SUMMARY

In general, in one aspect, an embodiment features a wearable audio device comprising: a processor; a microphone configured to provide first audio to the processor, wherein the first audio represents first sounds received by the microphone; and a loudspeaker configured to receive second audio from the processor, and to produce second sounds based on the second audio; wherein the processor is configured to generate a noise dose parameter based on the first audio.

Embodiments of the apparatus can include one or more of the following features. Some embodiments comprise a don/doff sensor configured to provide don/doff information; wherein the processor determines whether the wearable audio device is being worn based on the don/doff information; and wherein the processor generates the noise dose parameter only responsive to determining the wearable audio device is being worn. In some embodiments, the noise dose parameter includes at least one of: a noise level; a noise dose; and a time-weighted average of a plurality of the noise doses.

In some embodiments, the processor is further configured to cause the wearable audio device to generate a user-perceivable indication responsive to the noise dose parameter exceeding a selected threshold. Some embodiments comprise a transmitter; wherein the processor is further configured to cause the transmitter to transmit a signal representing the noise dose parameter. In some embodiments, the processor is further configured to determine a safe interval based on the noise dose parameter and a noise dose threshold, wherein the safe interval represents an interval during which further ones of the noise dose parameter will remain below the noise dose threshold; and the processor is further configured to cause the wearable audio device to generate a user-perceivable indication of the safe interval. Some embodiments comprise a location sensor configured to provide location information; and a transmitter; wherein the processor is further configured to determine a location associated with the noise dose parameter based on the location information; and wherein the processor is further configured to cause the transmitter to transmit a signal representing the noise dose parameter and the location associated with the noise dose parameter. Some embodiments comprise a monaural headset; and a detector configured to determine in which ear the monaural headset is being worn; wherein the processor is further configured to associate the noise dose parameter with the ear in which the monaural headset is not being worn. In some embodiments, the processor is further configured to determine a noise dose parameter for the ear in which the monaural headset is being worn based on i) the noise dose parameter for the ear in which the monaural headset is not being worn, and ii) an audio transfer function of the monaural headset.

In general, in one aspect, an embodiment features computer-readable media embodying instructions executable by a computer in a wearable audio device to perform functions comprising: receiving first audio, wherein the first audio represents sounds received by a microphone of the wearable audio device; generating second audio, and providing the second audio to a loudspeaker of the wearable audio device; and generating a noise dose parameter based on the first audio.

Embodiments of the computer-readable media can include one or more of the following features. In some embodiments, the functions further comprise: generating the noise dose parameter only responsive to the wearable audio device being worn. In some embodiments, the noise dose parameter includes at least one of: a noise level; a noise dose; and a time-weighted average of a plurality of the noise doses. In some embodiments, the functions further comprise: causing a user-perceivable indicator of the wearable audio device to generate a user-perceivable indication responsive to the noise dose parameter exceeding a selected threshold. In some embodiments, the functions further comprise: causing a transmitter of the wearable audio device to transmit a signal representing the noise dose parameter. In some embodiments, the functions further comprise: determining a safe interval based on the noise dose parameter and a noise dose threshold, wherein the safe interval represents an interval during which further ones of the noise dose parameter will remain below the noise dose threshold; and causing a user-perceivable indicator of the wearable audio device to generate a user-perceivable indication of the safe interval. In some embodiments, the functions further comprise: causing a transmitter of the wearable audio device to transmit a signal representing the noise dose parameter and a location associated with the noise dose parameter. In some embodiments, the wearable audio device is a monaural headset, and the functions further comprise: determining in which ear the monaural headset is being worn; and associating the noise dose parameter with the ear in which the monaural headset is not being worn. In some embodiments, the functions further comprise: determining a noise dose parameter for the ear in which the monaural headset is being worn based on i) the noise dose parameter for the ear in which the monaural headset is not being worn, and ii) an audio transfer function of the monaural headset.

In general, in one aspect, an embodiment features computer-readable media embodying instructions executable by a computer in a portable audio device to perform functions comprising: providing a noise level map, wherein the noise level map comprises a respective noise level for each of a plurality of locations; generating a predicted noise parameter based on a location of the portable audio device and the noise level map; and causing a user-perceivable indication of the predicted noise parameter to be generated by a wearable audio device in communication with the portable device.

Embodiments of the computer-readable media can include one or more of the following features. In some embodiments, the functions further comprise: generating navigation instructions based on a location of the portable device and the noise level map; and providing the instructions to a user by at least one of i) the wearable audio device, and ii) the portable device.

The details of one or more implementations are set forth in the accompanying drawings and the description below. Other features will be apparent from the description and drawings, and from the claims.

### DESCRIPTION OF DRAWINGS

FIG. 1 illustrates a communication system according to one embodiment.

FIG. 2 shows elements of the headset according to one embodiment.

FIG. 3 shows elements of the smartphone of FIG. 1 according to one embodiment.

FIG. 4 shows a process for the headset of FIGS. 1 and 2 according to one embodiment.

FIG. 5 shows a noise level mapping process for the server of FIG. 1 according to one embodiment.

FIG. 6 shows an example noise level map according to one embodiment.

FIG. 7 shows a noise level map utilization process for the smartphone of FIG. 3 according to one embodiment.

The leading digit(s) of each reference numeral used in this specification indicates the number of the drawing in which the reference numeral first appears.

### DETAILED DESCRIPTION

Embodiments of the present disclosure provide a personal noise meter in a wearable audio device. For convenience, the wearable audio device is described herein in terms of a headset having a microphone and loudspeaker. However, it will be understood that the wearable audio device may be implemented as any wearable device. For example, the wearable audio device may be implemented as a headset, bracelet, garment, or the like. Furthermore, the loudspeaker is not required. Other features are contemplated as well.

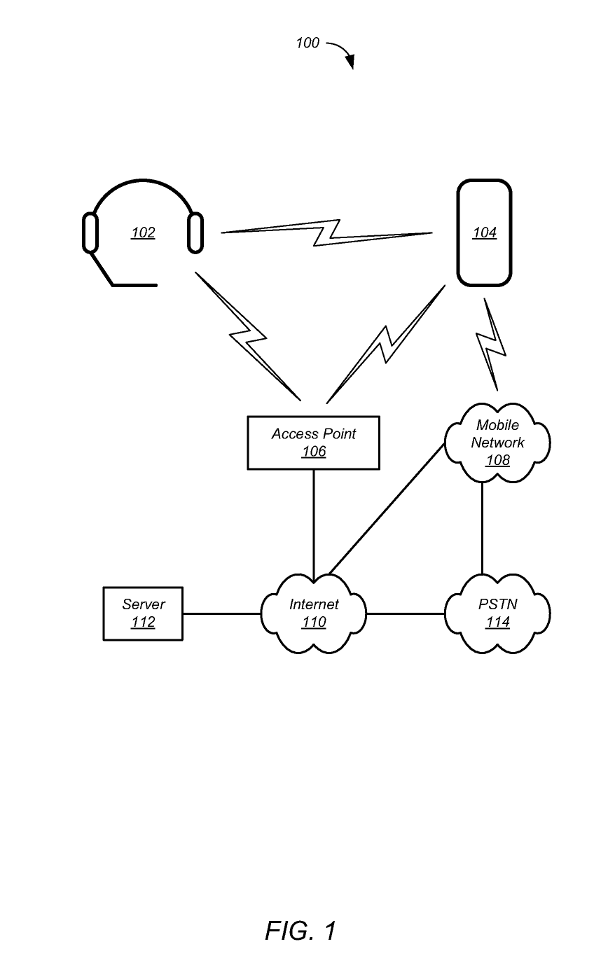

FIG. 1 illustrates a communication system 100 according to one embodiment. Referring to FIG. 1, the communication system 100 includes a headset 102, a smartphone 104, an access point 106, a mobile network 108, the Internet 110, a server 112, and a public switched telephone network (PSTN) 114. In the example of FIG. 1, the headset 102 is a wireless headset, and so may have a wireless connection to the smartphone 104. However, in other embodiments, the headset 102 may be a wired headset, and so may have a wired connection to the smartphone 104.

The wireless connection between the headset 102 and the smartphone 104 may be of any type. For example, the wireless connection may be a Bluetooth link, a DECT link, or the like. The headset 102 may have a Wi-Fi connection to an access point 106. The smartphone 104 may have a Wi-Fi connection to the access point 106. The access point 106 may be connected to the Internet 110. The smartphone 104 may have a mobile connection to the mobile network 108. The mobile network 108 may be connected to the Internet 110 and to the PSTN 114. The Internet 110 may be connected to the PSTN 114. The server 112 may be connected to the Internet 110.

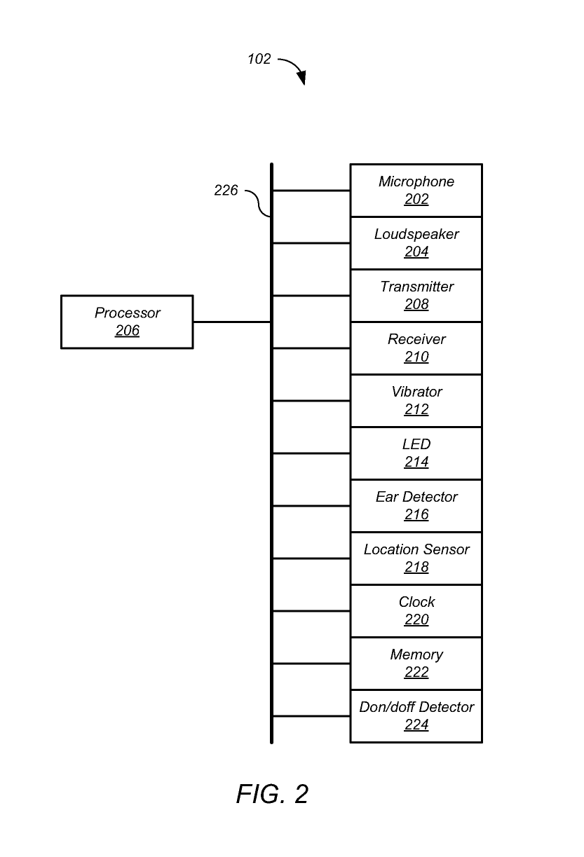

FIG. 2 shows elements of the headset 102 of FIG. 1 according to one embodiment. Although in the described embodiment elements of the headset 102 are presented in one arrangement, other embodiments may feature other arrangements. For example, elements of the headset 102 may be implemented in hardware, software, or combinations thereof.

Referring to FIG. 2, the headset 102 may include one or more microphones 202, a loudspeaker 204, a processor 206, one or more transmitters 208, one or more receivers 210, a vibrator 212, an LED 214, an ear detector 216, a location sensor 218, a clock 220, a memory 222, and a don/doff sensor 224. The headset 102 may include other elements as well. The transmitters 208 and receivers 210 may include wired and wireless transmitters 208 and receivers 210. The elements of the headset 102 may be interconnected by direct connections, by a bus 226, by a combination thereof, or the like.

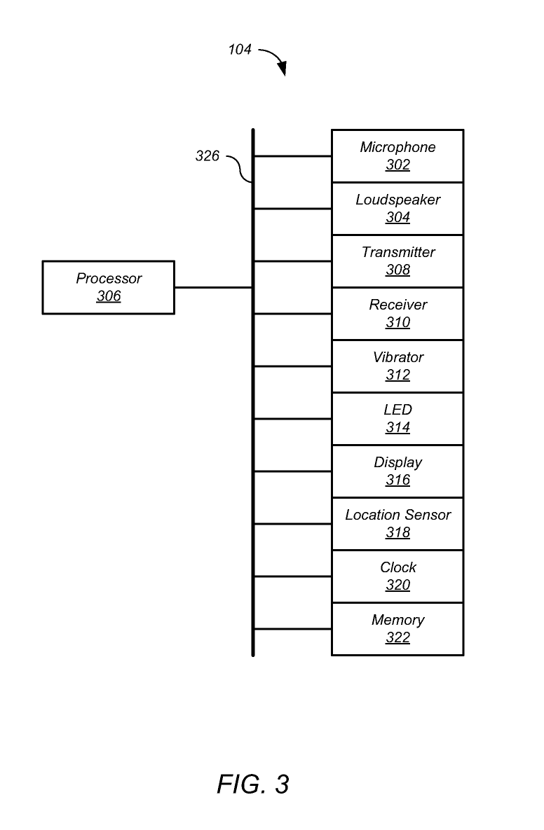

FIG. 3 shows elements of the smartphone 104 of FIG. 1 according to one embodiment. Although in the described embodiment elements of the smartphone 104 are presented in one arrangement, other embodiments may feature other arrangements. For example, elements of the smartphone 104 may be implemented in hardware, software, or combinations thereof.

Referring to FIG. 3, the smartphone 104 may include a microphone 302, a loudspeaker 304, a processor 306, one or more transmitters 308, one or more receivers 310, a vibrator 312, an LED 314, a display 316, a location sensor 318, a clock 320, and a memory 322. The smartphone 104 may include other elements as well. The transmitters 308 and receivers 310 may include wired and wireless transmitters 308 and receivers 310. The elements of the smartphone 104 may be interconnected by direct connections, by a bus 326, by a combination thereof, or the like.

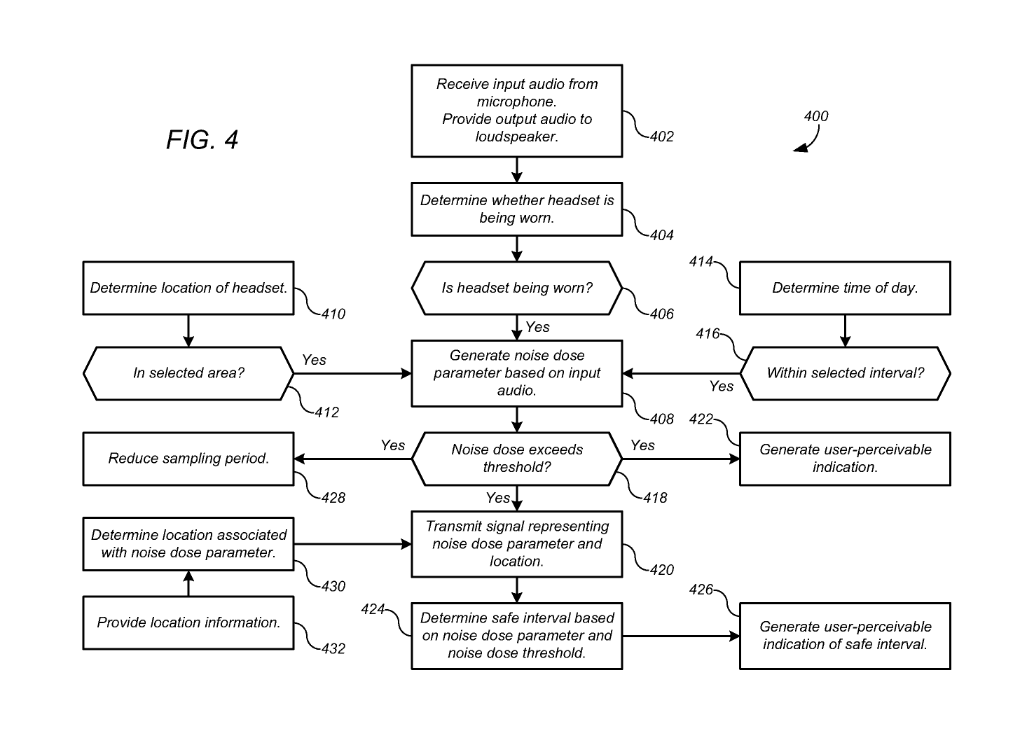

FIG. 4 shows a process 400 for the headset 102 of FIGS. 1 and 2 according to one embodiment. Although in the described embodiments the elements of process 400 are presented in one arrangement, other embodiments may feature other arrangements. For example, in various embodiments, some or all of the elements of process 400 can be executed in a different order, concurrently, and the like. Also some elements of process 400 may not be performed, and may not be executed immediately after each other. In addition, some or all of the elements of process 400 can be performed automatically, that is, without human intervention. In some embodiments, some of the steps may be performed by corresponding elements of the smartphone 104, the server 112, or a combination thereof.

Referring to FIG. 4, at 402, the processor 206 receives input audio from the microphone 202. The input audio represents sounds received by the microphone 202. In embodiments having a loudspeaker 204, the processor 206 provides output audio to the loudspeaker 204, and the loudspeaker 204 produces sounds based on the output audio. At 404, the processor 206 determines whether the headset 102 is being worn based on information provided by the don/doff sensor 224. At 406, if the headset 102 is being worn, then at 408, the processor 206 generates a noise dose parameter based on the input audio provided by the microphone 202.

In some embodiments, the processor 206 generates noise dose parameters only under certain conditions. For example, the processor 206 may generate noise dose parameters only when the headset 102 is located within a selected area such as the wearer's workplace. In such an embodiment, the noise dose parameters may represent only the noise exposure incurred within the scope of the wearer's employment. At 410, the processor 206 may determine a location of the headset 102 based on location information provided by the location sensor 218. At 412, only when the location is within a selected area does the processor 206 generate a noise dose parameter, at 408. The processor 206 may determine the location in any manner. For example, the location may be determined using triangulation on signals such as global positioning system (GPS) signals, digital television signals, cellular signals, Wi-Fi signals, or the like, using inertial navigation or the like, or any combination thereof.

As another example, the processor 206 may generate noise dose parameters only during a selected interval such as the wearer's working hours. In such an embodiment, the noise dose parameters may represent only the noise exposure incurred within the scope of the wearer's employment. At 414, the processor 206 may determine a time of day based on time information provided by the clock 220. At 416, only when the time of day is within a selected interval does the processor 206 generate a noise dose parameter, at 408.

The audio provided by the microphone 202 may represent not only vocal sounds of a user of the headset 102, but also other sounds such as background noise, noise from particular noise sources, and the like. In some embodiments, the processor 206 generates the noise dose parameter based only on these other sounds. In some embodiments, the processor 206 generates the noise dose parameter based only on the vocal sounds. In some embodiments, the processor 206 generates the noise dose parameter based on both vocal sounds and background sounds. Any sort of technique may be used to distinguish the vocal sounds from the background sounds. For example, conventional voice activity detection may be used.

The noise dose parameters are independent of device, and may be collected for an individual despite changing wearable audio devices. The noise dose parameter generated by the processor 206 may include a noise level, noise dose, a time-weighted average of a plurality of the noise doses, or the like, or any combination thereof. For example, a noise dose may be calculated as shown in equation (1).

Noise Dose=100×(C1/T1+C2/T2+C3/T3+ . . . +Cn/Tn) (1)

where

Tn=8/(2**((L−90)/5)) (2)

L is the measured sound level, and Cn is the time spent at that noise level. Alternatively, a look-up table may be used.

An eight-hour time-weighted average (TWA) may be calculated, for example, as shown in equation (3).

TWA=16.61 Log 10(D/100)+90 (3)

where D is the noise dose, for example from equation (1), and Log 10 is the base-10 logarithm.

When the headset 102 is a monaural headset, the ear detector 216 may determine in which ear the headset 102 is being worn. Because that ear is protected to some extent by the headset 102, the processor 206 associates the noise dose parameter with the other ear. When the audio transfer function of the headset is known, the processor 206 may use the noise dose parameter and the audio transfer function to determine a noise dose parameter for the ear in which the headset 102 is being worn. For a binaural headset, the processor 206 may use the noise dose parameter and the audio transfer function to determine a noise dose parameter for both ears.

At 418, responsive to the noise dose parameter exceeding the selected threshold, at 420, the processor 206 may cause the transmitter 208 to transmit the signal representing the noise dose parameter. The signal representing the noise dose parameter may be transmitted regularly, when the noise dose parameter exceeds a selected threshold, or both. The signal may be transmitted to the server 112 (FIG. 1). The server 112 may use the noise dose parameters to build records detailing noise exposure for individuals, for groups, for locations, for areas, for intervals, and the like, or any combination thereof.

At 418, responsive to the noise dose parameter exceeding a selected threshold, at 422, the processor 206 may cause a user-perceivable indicator to generate a user-perceivable indication. For example, the processor 206 may cause the loudspeaker 204 of the headset 102, or the loudspeaker 304 of the smartphone 104, to play a warning message. As another example, the processor 206 may cause the vibrator 212 of the headset 102, or the vibrator 312 of the smartphone 104, to vibrate. As another example, the processor 206 may cause the LED 214 of the headset 102, or the LED 314 of the smartphone 104, to turn on, change color, or flash. As another example, the processor 206 may cause the display 316 of the smartphone 104, to display a warning message, icon, or the like.

In some embodiments, the headset 102 may determine a safe interval during which the wearer of the headset 102 may safely continue to receive the noise dose. At 424, the processor 206 determines a safe interval based on the noise dose parameter and a noise dose threshold. The safe interval represents an interval during which further noise dose parameters will remain below the noise dose threshold. At 426, the processor 206 causes a user-perceivable indicator to generate a user-perceivable indication of the safe interval. For example, the processor 206 may cause the loudspeaker 204 of the headset 102, or the loudspeaker 304 of the smartphone 104, to play a message. As another example, the processor 206 may cause the display 316 of the smartphone 104 to display a message, icon, or the like.

The processor 206 may sample the audio periodically according to a sampling period. At 418, responsive to the noise dose parameter exceeding the selected threshold, at 428, the processor 206 may reduce the sampling period.

At 430, the location sensor 218 may provide location information. At 432, the processor 206 may determine a location associated with the noise dose parameter based on the location information. At 420, the transmitted signal may include the location associated with the noise dose parameter.

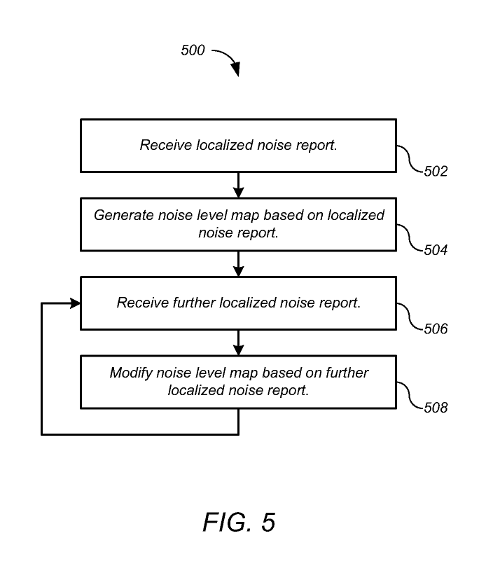

In some embodiments, the noise dose parameters and associated locations are used to generate and modify a noise level map. FIG. 5 shows a noise level mapping process 500 for the server 112 of FIG. 1 according to one embodiment. Although in the described embodiments the elements of process 500 are presented in one arrangement, other embodiments may feature other arrangements. For example, in various embodiments, some or all of the elements of process 500 may be executed in a different order, concurrently, and the like. Also some elements of process 500 may not be performed, and may not be executed immediately after each other. In addition, some or all of the elements of process 500 may be performed automatically, that is, without human intervention. In the described embodiment, the noise level map is generated by the server 112. However, in various embodiments, the noise level map may be generated and modified by the headset 102, by the smartphone 104, by the server 112, or any combination thereof.

Referring to FIG. 5, at 502, the server 112 receives a localized noise report. Each localized noise report includes a noise dose parameter generated by a headset 102 and the location where the noise dose parameter was determined. For example, the headset 102 may determine the noise dose parameter as described above. The processor 206 may also determine the location at the time the noise parameter was determined. The processor 206 may then associate the location and noise dose parameter to form a localized noise report, and then transmit the report to the server 112.

At 504, the server 112 generates a noise level map based on the localized noise report. Any technique may be used to generate the noise level map. For example, the server 112 may generate a noise level index for the reported location based on the reported noise dose parameter. The noise level index may be expressed on a scale from one to four, for example. The map may be a heat map. For example, the heat map may be generated by digitally filtering the array of noise level indices, or the like. In some embodiments, noise level maps may be generated for selected times, days, weeks, months, years, and the like. The noise level maps have many uses. For example, the maps may be used to devise seating plans for individuals with high noise sensitivity.

At 506, the server 112 receives a further localized noise report. At 508, the server 112 modifies the noise level map based on the further localized noise report. For example, if the reported location has no noise level index in the map, the server 112 generates a noise level index for the reported location in the map based on the reported noise dose parameter. But if the reported map location has a noise level index, the server 112 modifies the noise level index for that map location based on the existing noise level index and the reported noise dose parameter. The process 500 may resume, at 504.

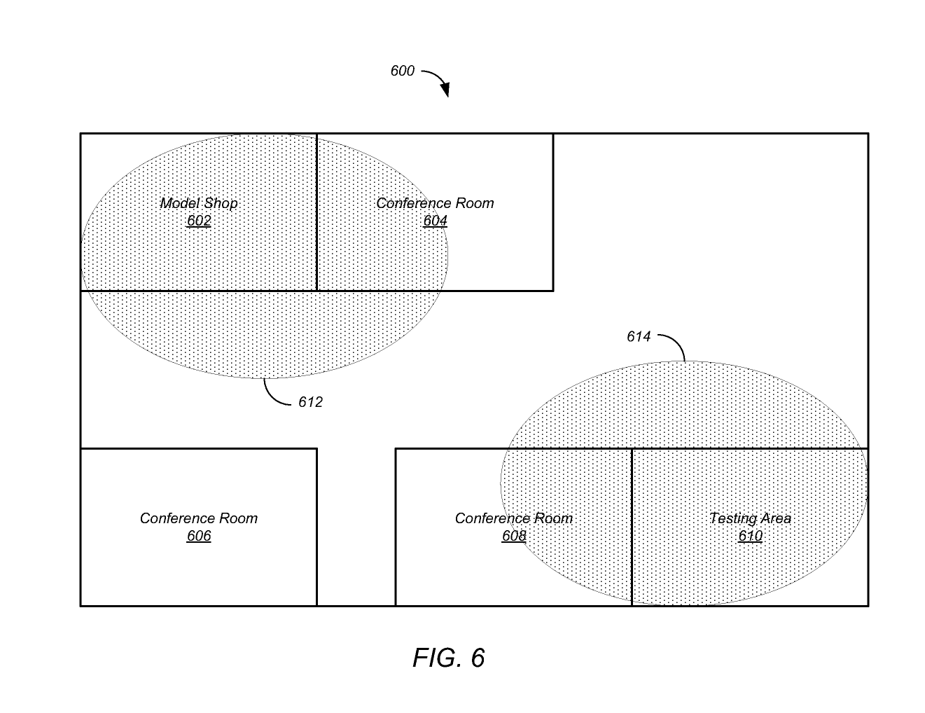

FIG. 6 shows an example noise level map according to one embodiment. The noise level map shows a building 600 having a model shop 602, three conference rooms 604, 606, 608, and a testing area 610. In this example, the noise level map is a heat map having only two values: acceptable and unacceptable. The noise level map shows two areas of unacceptable noise levels. One area 612 is associated with the model shop 602, and could be caused by modeling machinery. Another area 614 is associated with the testing area 610, and could be caused by test equipment. The remaining areas of the building 600 have acceptable noise levels. A user consulting the map to avoid high noise doses would probably avoid the model shop 602, the testing area 610, and conference rooms 604 and 608, which are covered or partially covered by areas 612 and 614 respectively, and could move to conference room 606, which is not covered by either of those areas 612, 614.

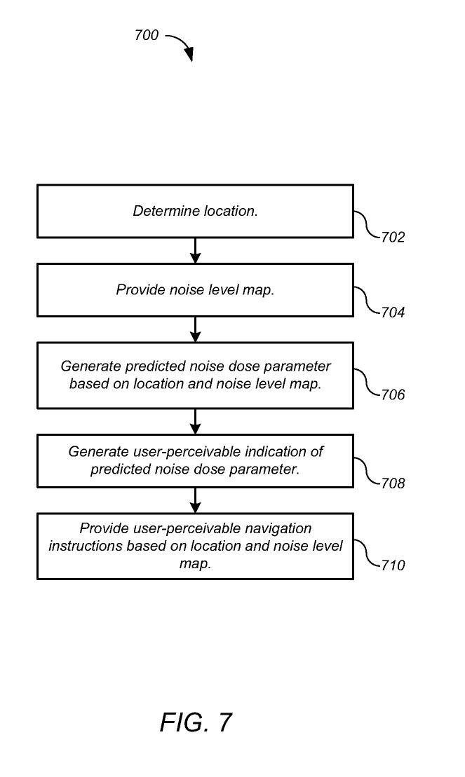

In some embodiments, the noise level map is used to predict the noise dose parameter based on the location of the smartphone 104. FIG. 7 shows a noise level map utilization process 700 for the smartphone 104 of FIG. 3 according to one embodiment. Although in the described embodiments the elements of process 700 are presented in one arrangement, other embodiments may feature other arrangements. For example, in various embodiments, some or all of the elements of process 700 may be executed in a different order, concurrently, and the like. Also some elements of process 700 may not be performed, and may not be executed immediately after each other. In addition, some or all of the elements of process 700 may be performed automatically, that is, without human intervention.

Referring to FIG. 7, at 702, the headset 102 or smartphone 104 determines its location. The location may be determined in any manner. For example, the location may be determined using triangulation on signals such as global positioning system (GPS) signals, digital television signals, cellular signals, Wi-Fi signals, or the like, using inertial navigation or the like, or any combination thereof.

At 704, the smartphone 104 provides a noise level map. In some embodiments, the noise level map may be generated by the smartphone 104, and may be stored in the memory 322 of the smartphone 104. In some embodiments, the noise level map may be generated by the server 112, and may be sent to the smartphone 104 by the server 112.

At 706, the smartphone 104 generates a predicted noise dose parameter based on the location of the smartphone 104 and the noise level map. For example, the predicted noise dose parameter may be the noise level index associated with the location of the smartphone 104 by the noise level map.

At 708, the smartphone 104, the headset 102, or both generates a user-perceivable indication of the predicted noise dose parameter. For example, the processor 232 may send an audio message to the headset 102 that indicates the predicted noise dose parameter and, responsive to receiving that message, the headset 102 may play the message over its loudspeaker 204. As another example, the smartphone 104 may display the indication of the predicted noise dose parameter on its display screen 234. For example, the display screen 234 may show a heat map with the location of the smartphone 104 indicated thereon.

In some embodiments, at 710, the smartphone 104 provides user-perceivable navigation instructions based on the location of the smartphone 104 and the noise level map. For example, the instructions may guide the user away from areas where the predicted noise dose parameter is high, toward areas where the predicted noise dose parameter is low, and the like. In addition, the instructions may prompt the user to take some action, for example such as turning on automatic noise reduction in the headset 102, donning a more protective headset 102, and the like.

Various embodiments of the present disclosure can be implemented in digital electronic circuitry, or in computer hardware, firmware, software, or in combinations thereof. Embodiments of the present disclosure can be implemented in a computer program product tangibly embodied in a computer-readable storage device for execution by a programmable processor. The described processes can be performed by a programmable processor executing a program of instructions to perform functions by operating on input data and generating output. Embodiments of the present disclosure can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, processors receive instructions and data from a read-only memory and/or a random access memory. Generally, a computer includes one or more mass storage devices for storing data files. Such devices include magnetic disks, such as internal hard disks and removable disks, magneto-optical disks; optical disks, and solid-state disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). As used herein, the term “module” may refer to any of the above implementations.

A number of implementations have been described. Nevertheless, various modifications may be made without departing from the scope of the disclosure. Accordingly, other implementations are within the scope of the following claims.

What is claimed is:

1. A wearable audio device comprising:
a processor;
a microphone configured to provide first audio to the processor, wherein the first audio represents first sounds received by the microphone; and
a loudspeaker configured to receive second audio from the processor, and to produce second sounds based on the second audio;
wherein the processor is configured to generate a noise dose parameter based on the first audio.

2. The wearable audio device of claim 1, further comprising:
a don/doff sensor configured to provide don/doff information;
wherein the processor determines whether the wearable audio device is being worn based on the don/doff information; and
wherein the processor generates the noise dose parameter only responsive to determining the wearable audio device is being worn.

3. The wearable audio device of claim 1, wherein the noise dose parameter includes at least one of:
a noise level;
a noise dose; and
a time-weighted average of a plurality of the noise doses.

4. The wearable audio device of claim 1, wherein:
the processor is further configured to cause the wearable audio device to generate a user-perceivable indication responsive to the noise dose parameter exceeding a selected threshold.

5. The wearable audio device of claim 1, further comprising:
a transmitter;
wherein the processor is further configured to cause the transmitter to transmit a signal representing the noise dose parameter.

6. The wearable audio device of claim 1, wherein:
the processor is further configured to determine a safe interval based on the noise dose parameter and a noise dose threshold, wherein the safe interval represents an interval during which further ones of the noise dose parameter will remain below the noise dose threshold; and
the processor is further configured to cause the wearable audio device to generate a user-perceivable indication of the safe interval.

7. The wearable audio device of claim 1, further comprising:
a location sensor configured to provide location information; and
a transmitter;
wherein the processor is further configured to determine a location associated with the noise dose parameter based on the location information; and
wherein the processor is further configured to cause the transmitter to transmit a signal representing the noise dose parameter and the location associated with the noise dose parameter.

8. The wearable audio device of claim 1, further comprising:
a monaural headset; and
a detector configured to determine in which ear the monaural headset is being worn;
wherein the processor is further configured to associate the noise dose parameter with the ear in which the monaural headset is not being worn.

9. The wearable audio device of claim 8, wherein:
the processor is further configured to determine a noise dose parameter for the ear in which the monaural headset is being worn based on
i) the noise dose parameter for the ear in which the monaural headset is not being worn, and
ii) an audio transfer function of the monaural headset.

10. Computer-readable media embodying instructions executable by a computer in a wearable audio device to perform functions comprising:
receiving first audio, wherein the first audio represents sounds received by a microphone of the wearable audio device;
generating second audio, and providing the second audio to a loudspeaker of the wearable audio device; and
generating a noise dose parameter based on the first audio.

11. The computer-readable media of claim 10, wherein the functions further comprise:
generating the noise dose parameter only responsive to the wearable audio device being worn.

12. The computer-readable media of claim 10, wherein the noise dose parameter includes at least one of:
a noise level;
a noise dose; and
a time-weighted average of a plurality of the noise doses.

13. The computer-readable media of claim 10, wherein the functions further comprise:
causing a user-perceivable indicator of the wearable audio device to generate a user-perceivable indication responsive to the noise dose parameter exceeding a selected threshold.

14. The computer-readable media of claim 10, wherein the functions further comprise:
causing a transmitter of the wearable audio device to transmit a signal representing the noise dose parameter.

15. The computer-readable media of claim 10, wherein the functions further comprise:
determining a safe interval based on the noise dose parameter and a noise dose threshold, wherein the safe interval represents an interval during which further ones of the noise dose parameter will remain below the noise dose threshold; and
causing a user-perceivable indicator of the wearable audio device to generate a user-perceivable indication of the safe interval.

16. The computer-readable media of claim 10, wherein the functions further comprise:
causing a transmitter of the wearable audio device to transmit a signal representing the noise dose parameter and a location associated with the noise dose parameter.

17. The computer-readable media of claim 10, wherein the wearable audio device is a monaural headset, and wherein the functions further comprise:
determining in which ear the monaural headset is being worn; and
associating the noise dose parameter with the ear in which the monaural headset is not being worn.

18. The computer-readable media of claim 17, wherein the functions further comprise:
determining a noise dose parameter for the ear in which the monaural headset is being worn based on
i) the noise dose parameter for the ear in which the monaural headset is not being worn, and
ii) an audio transfer function of the monaural headset.

19. Computer-readable media embodying instructions executable by a computer in a portable audio device to perform functions comprising:
providing a noise level map, wherein the noise level map comprises a respective noise level for each of a plurality of locations;
generating a predicted noise parameter based on a location of the portable audio device and the noise level map; and
causing a user-perceivable indication of the predicted noise parameter to be generated by a wearable audio device in communication with the portable device.

20. The computer-readable media of claim 19, wherein the functions further comprise:
generating navigation instructions based on a location of the portable device and the noise level map; and
providing the instructions to a user by at least one of
i) the wearable audio device, and
ii) the portable device.
